(19) United States
(12) Patent Application Publication
(10) Pub. No.: US 2014/0009597 A1
(43) Pub. Date: Jan. 9, 2014

(54) MICROSCOPE APPARATUS AND CONTROL METHOD FOR SAME

(71) Applicant: CANNON KABUSHIKI KAISHA, Tokyo (JP)

(72) Inventor: Naoto Abe, Machida-shi (JP)

(21) Appl. No.: 13/930,397

(22) Filed: Jun. 28, 2013

(30) Foreign Application Priority Data
Jul. 5, 2012 (JP) 2012-151170
Jan. 22, 2013 (JP) 2013-009163

(51) Int. Cl. G06K 9/00

(52) U.S. Cl. CPC G06K 9/00147
USPC 348/80

(57) ABSTRACT

A microscope apparatus which captures images of an object by image sensors having different focusing positions in an optical axis direction and acquires image data of plural layers of the object, includes: a judgment unit which divides a whole region of the image data obtained from the image sensors into plural blocks and judges whether or not each block includes an object image; and a data reducing unit which reduces a data volume of the image data of all of the layers in a block which is judged not to include an object image. The judgment unit selects two or more layers from a block which is being subjected to judgment, respectively evaluates whether or not the image data of the selected layers includes the object image, and judges whether or not the block includes the object image on the basis of the evaluation results.

### BACKGROUND OF THE INVENTION

1. Field of the Invention

The present invention relates to a microscope apparatus and in particular, to a microscope apparatus which captures images of an object and acquires a plurality of image data having different focusing positions.

2. Description of the Related Art

In recent years, in the field of pathology, attention has been drawn to systems for examining and diagnosing digital images obtained by capturing images of a specimen under observation (object), on a display monitor, as an alternative to an optical microscope. This type of system is called a “digital microscope system” or a “virtual slide system”. Since the object has thickness and the depth of field of the microscope is extremely shallow, there are cases where an operation is carried out to acquire, from one object, a plurality of two-dimensional image data having slightly different focusing positions in the optical axis direction (Z direction) on the object side. In the present specification, a two-dimensional image data group which is obtained by an operation of this kind is called “Z stack image data” and the two-dimensional image data of each layer constituting the Z stack image data is called “layer image data”.

International Publication No. WO 2007/095090 A2 (PTL 1) discloses a digital microscope system which acquires Z stack image data. International Publication No. WO 2007/095090 A2 (PTL 1) discloses a digital image acquisition system in which a plurality of line image sensors (one-dimensional image sensors) having different focusing positions are installed and Z stack image data is acquired at high-speed by reading in image capture outputs of the plurality of line image sensors.

The Z stack image data is advantageous in enabling observation of the three-dimensional structure of an object, but is disadvantageous in that the data volume increases accordingly. In particular, in recent years, there have been increasing user demands for images of higher definition and greater size and increase in the number of layers, and hence increase in the volume of data has become a major problem. Furthermore, this is undesirable in the case of a system which carries out batch processing of image capture and digitalization of a plurality of objects, since the increase in the respective data volumes gives rise to a decline in through-put and leads to decrease in the number of objects that can be stored in (in other words, which can be continuously processed by) a storage apparatus.

### SUMMARY OF THE INVENTION

The present invention was devised in view of the circumstances described above, an object thereof being to provide technique for reducing the data volume of Z stack image data.

The present invention in its first aspect provides a microscope apparatus which captures images of an object by a plurality of image sensors having different focusing positions in an optical axis direction and acquires image data of a plurality of layers of the object, comprising: a judgment unit which divides a whole region of the image data obtained from the image sensors into a plurality of blocks and judges whether or not each block includes an object image; and a data reducing unit which reduces a data volume of the image data of all of the layers in a block which is judged by the judgment unit not to include an object image, wherein the judgment unit selects two or more layers from a plurality of layers of a block which is being subjected to judgment, respectively evaluates whether or not the image data of the two or more selected layers includes the object image, and judges whether or not the block includes the object image on the basis of the evaluation results.

The present invention in its second aspect provides a control method for a microscope apparatus which captures images of an object by a plurality of image sensors having different focusing positions in an optical axis direction and acquires image data of a plurality of layers of the object; the control method comprising: a judgment step of dividing a whole region of the image data obtained from the image sensors into a plurality of blocks and judging whether or not each block includes an object image; and a data reducing step of reducing a data volume of the image data of all of the layers in a block which is judged in the judgment step not to include an object image; wherein, in the judgment step, two or more layers are selected from a plurality of layers of a block which is being subjected to judgment, it is respectively evaluated whether or not the image data of the two or more selected layers includes the object image, and it is judged whether or not the block includes the object image on the basis of the evaluation results.

According to the present invention, it is possible to reduce the data volume of Z stack image data.

Further features of the present invention will become apparent from the following description of exemplary embodiments with reference to the attached drawings.

### BRIEF DESCRIPTION OF THE DRAWINGS

FIG. 1 is a block diagram of a microscope apparatus according to a first embodiment of the present invention;

FIG. 2 is a diagram showing a flow of image data reduction processing according to the first embodiment of the present invention;

FIG. 3 is a diagram showing a flow of a first judgment method for judging the presence or absence of an object;

FIG. 4 is a diagram showing a flow of a second judgment method for judging the presence or absence of an object;

FIG. 5 is a diagram showing a flow of a third judgment method for judging the presence or absence of an object;

FIG. 6A and FIG. 6B are diagrams showing a flow of image data reduction processing according to a second embodiment of the present invention;

FIG. 7 is a diagram showing a flow of image data reduction processing according to a third embodiment of the present invention;

FIG. 8 is a schematic drawing for describing Z stack image data;

FIG. 9 is a diagram showing a schematic view of Z stack image data according to the first embodiment of the present invention;

FIG. 10 is a diagram showing a schematic view of Z stack image data according to the second embodiment of the present invention;

FIG. 11 is a diagram showing a schematic view of Z stack image data according to the third embodiment of the present invention; and

FIG. 12A and FIG. 12B are diagrams showing schematic views of the composition of an optical system and image sensors.

### DESCRIPTION OF THE EMBODIMENTS

The present invention relates to a microscope apparatus which is applied to a digital microscope system, and more particularly, is applied preferably to a microscope apparatus having a function for capturing images of the object and acquiring image data of a plurality of layers (Z positions) of the object. The present invention adopts a composition such as the following in order to reduce the data volume of Z stack image data which is composed of a plurality of layer image data. The whole region of the image data (image capture region) is divided into a plurality of blocks, each block is judged as to whether the block includes an object image, and the data volume of the image data of all of the layers is reduced in respect of blocks that are judged not to include an object image. Consequently, it is possible to reduce the data volume of the Z stack image data without impairing the amount of information (in other words, the object images) required for observation and diagnosis. Here, in order to improve the reliability of judgment of the presence and absence of an object image, an evaluation is carried out to determine whether or not image data of two or more layers includes an object image, and these evaluation results are considered together in order to provide a final judgment of whether or not the block in question includes an object image. Moreover, when selecting the two or more layers used for evaluation, layers should be selected in such a manner that an object image is included in the image data of at least one of the selected layers (in cases where an object is present). Consequently, it is possible to prevent, as far as possible, an erroneous judgment that no object image is included, despite the fact that an object is present.

A desirable mode for carrying out the present invention is described below with reference to the drawings.

(Z Stack Image Data)

Initially, Z stack image data captured by a digital microscope apparatus will be described.

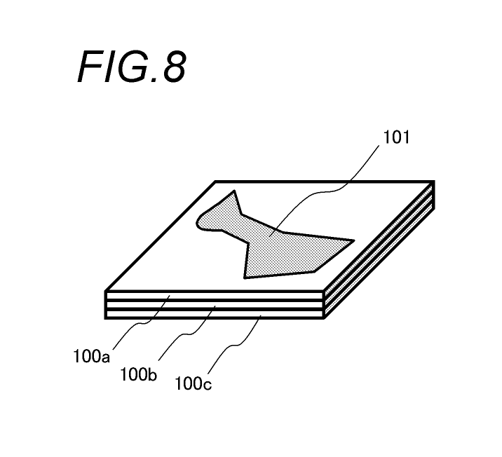

FIG. 8 is a schematic diagram for briefly describing Z stack image data, and shows a schematic view of Z stack image data which is composed of three layer images. Of course, the number of layer images is not limited to three, and it is possible to create Z stack image data by a number of layers (desired number of layers) required by the observer.

In FIG. 8, 100a, 100b, 100c are schematic representations of layer image data of respective layers. The respective layer image data 100a, 100b, 100c are captured by varying the focusing position (focal depth) with respect to the object in the optical axis direction, and an object image 101 corresponding to a cross-section of the object appears in each layer image data. The layer image data 100a to 100c is two-dimensional image data and each pixel thereof is constituted by RGB, 8-bit data. This Z stack image data can be three-dimensional image data which represents a three-dimensional structure of the object. In other words, the X, Y directions correspond to the planar direction of the layer images and the Z direction corresponds to the depth direction (optical axis direction). The intervals between the layers (focusing position planes) can be set to be slightly narrower than the depth of field of the optical system of the microscope apparatus, for example. If the intervals between the focusing position planes are set to be slightly narrower than the depth of field, then it is possible to obtain in-focus image data in at least one layer. If the interval between the focusing position planes is set to be broader than the depth of field, then there is a possibility that the object may be out of focus in any of the layers, and hence this is unsuitable for capturing images of the object.

The Z stack image data is displayed by a viewer, which is observation software. With the viewer, for example, the observer is able to display image data of a designated layer by means of a pointing device, such as a mouse, to artificially change the depth of field (amount of blurring of the image) by image processing, or to display the object three-dimensionally. Consequently, the observer is able to observe the three-dimensional structure of the object in a suitable fashion.

### First Embodiment

The method of acquiring the Z stack image data in the first embodiment of the present invention is a method for capturing a plurality of focusing position planes (Z positions) of a single object, in parallel fashion, using a plurality of image sensors having different focusing positions, and acquiring the layer image data of a desired number of layers in substantially simultaneous fashion. The reason for using the term “substantially simultaneous” here is that since there is a difference in the positions of the image sensors (line image sensors) in the sub-scanning direction, there is a slight time deviation in the imaging start timing and the imaging end timing of each layer. In other words, although the acquisition times of the image data of each layer are not strictly simultaneous, since a plurality of layer image data are obtained in one scan (sub-scanning action, in other words, a relative movement of the object and the image sensor group), then the term “substantially simultaneous” is used with the meaning of “in the same scan”.

In the first embodiment of the present invention, in order to reduce the data volume of the Z stack image data, the whole region of the image data (XY plane) is divided into a plurality of blocks, and in each block, it is judged whether or not the block includes an object image, and image data of a block that does not include an object image is discarded. Various methods can be employed for evaluating and judging whether or not a block includes an object image. For example, it is possible to evaluate the image data of all of the layers (Z positions) or to evaluate image data of a portion of the layers (representative layers). Moreover, the presence or absence of an object image can be evaluated by using a characteristic amount which is extracted from an image (for example, brightness, color, frequency component, contrast, dispersion, etc.). A concrete example of an evaluation and judgment method is described below.

The data reducing method according to the present embodiment is suitable for a digital microscope apparatus which captures images of an object mounted on a preparation (also called a slide). This is because what the observer wishes to view in the image acquired by a digital microscope apparatus is always the object, and if the object is mounted on a preparation, then portions where the object is absent are relatively likely to occur.

(Composition of Optical System and Image Sensors)

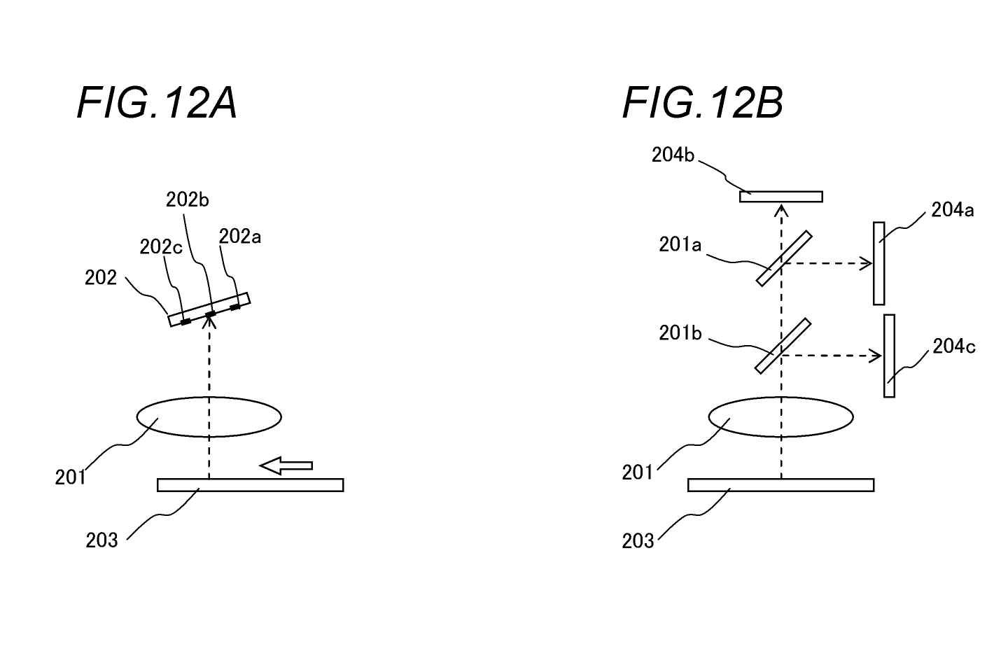

FIG. 12A and FIG. 12B are diagrams showing schematic views of the composition of an optical system and image sensors which are suitable for a microscope apparatus according to the present embodiment.

FIG. 12A is a diagram showing a composition using a line image sensor. In FIG. 12A, reference numeral 201 denotes an optical system, such as an object lens, and reference numeral 202 denotes an imaging unit. The imaging unit 202 is constituted by a plurality of image sensors (line image sensors) 202a, 202b, 202c having different focusing positions. For example, the imaging unit 202 is achieved by one semiconductor chip (die) and is desirably constituted by a semiconductor chip on which a plurality of line image sensors are formed in parallel with the main scanning direction on a die. By installing this semiconductor chip obliquely with respect to a plane perpendicular to the optical axis of the optical system 201, it is possible to vary the respective focusing positions by achieving slightly different lengths of the optical path (optical distance) from the optical system 201 to the respective line image sensors 202a, 202b, 202c. In the example in FIG. 12A, the semiconductor chip is installed in such a manner that the optical path length from the optical system 201 to the line image sensor is shortest in the case of the line image sensor 202c and is longest in the case of line image sensor 202a. Consequently, the focusing position on the object side is deepest (furthest from the optical system 201) in the case of the line image sensor 202c and shallowest (nearest to the optical system 201) in the case of the line image sensor 202a. Reference numeral 203 denotes a stage, which moves an object on a preparation (not illustrated) in synchronism with image capture by the line image sensors 202a, 202b, 202c in the direction perpendicular to the main scanning direction of the line image sensors 202a, 202b, 202c (namely, in the sub-scanning direction). More specifically, the stage moves the object in the direction of the white arrow in FIG. 12A. When sub-scanning has been completed, image capture data of one layer in the focusing position plane (Z direction) is output respectively from each of the line image sensors 202a, 202b, 202c.

FIG. 12B is a diagram showing a composition using area image sensors (two-dimensional image sensor). In FIG. 12B, reference numerals 201a, 201b denote a half mirror and reference numerals 204a, 204b, 204c denote an area image sensor. The half mirrors 201a, 201b are optical apparatuses for splitting the optical image of the object guided by the optical system 201 into respective optical paths. The area image sensors 204a, 204b, 204c are arranged in such a manner that the optical path lengths from the optical system 201 to the sensors are respectively different. In the example in FIG. 12B, the semiconductor chip is installed in such a manner that the optical path length from the optical system 201 to the area image sensor is shortest in the case of the area image sensor 204c and is longest in the case of area image sensor 204a. Consequently, the focusing position on the object side is deepest (furthest from the optical system 201) in the case of the area image sensor 204c and shallowest (nearest to the optical system 201) in the case of the area image sensor 204a. The optical characteristics of the half mirrors 201a, 201b are set in such a manner that the intensity of the light directed to the respective area image sensors 204a, 204b, 204c is equal. This is because it enables matching of the qualities (SN ratio) of the layer image data of the respective layers.

In FIG. 12A and FIG. 12B, there are three image sensors. This number is set in order to make the description easier to understand, and in actual practice, it is appropriate to establish and install a number of image sensors in accordance with the (desired) Z positions required by the observer.

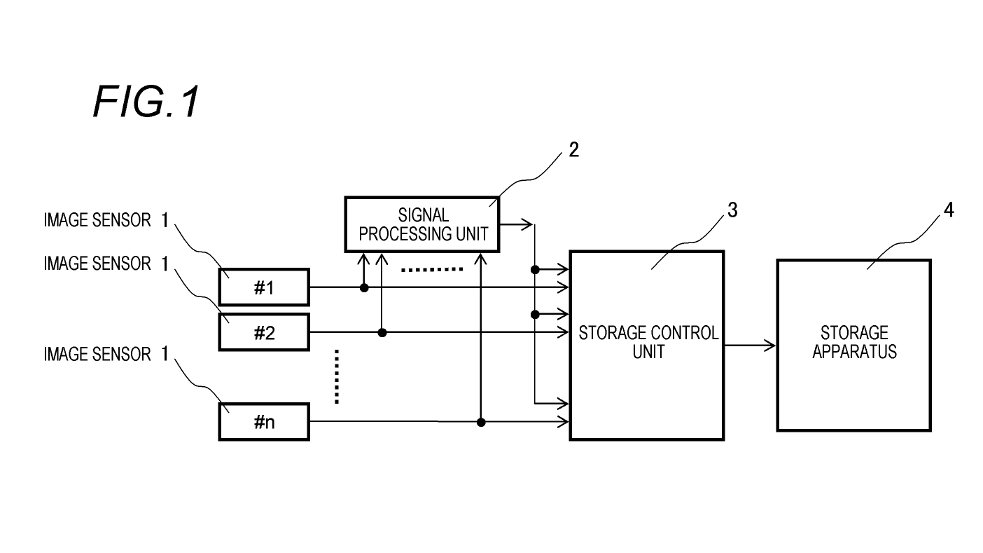

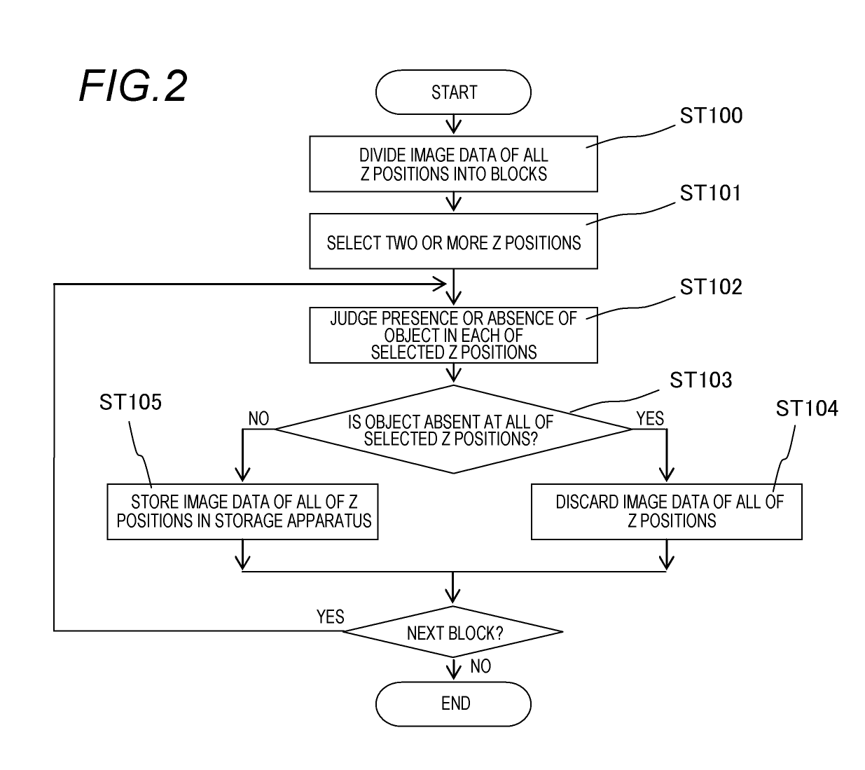

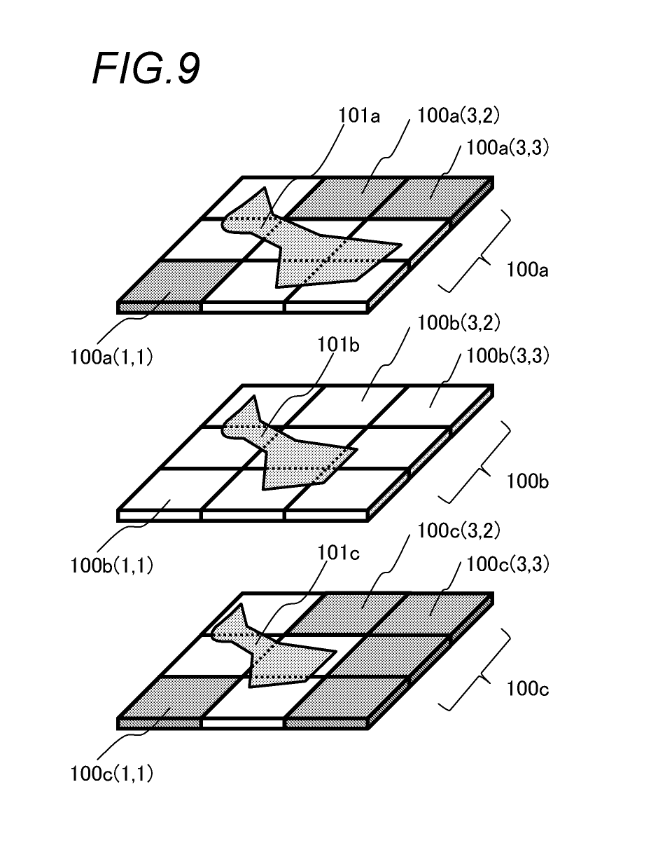

Next, the signal processing system of the digital microscope apparatus according to the present embodiment will be described. FIG. 1 is a block diagram of a function for processing image data in the microscope apparatus. In FIG. 1, reference numeral 1 denotes n image sensors, which correspond to the line image sensors 202a, 202b, 202c shown in FIG. 12A or the area image sensors 204a, 204b, 204c shown in FIG. 12B, for instance. Reference numeral 2 denotes a signal processing unit, reference numeral 3 denotes a storage control unit and reference numeral 4 denotes a storage apparatus. In this composition, the signal processing unit 2 and the storage control unit 3 correspond to a judgment unit and a data reducing unit in the present invention. The signal processing unit 2 and the storage control unit 3 may be constituted by a single microcomputer, for example, or may be realized respectively by a logic circuit, such as an FPGA, provided that the processing flow described below can be executed. FIG. 2 is a diagram showing a flow of image data reduction processing in the first embodiment. FIG. 9 is a diagram showing a schematic view of Z stack image data according to the first embodiment. In FIG. 9, the reference numerals described with reference to FIG. 8 are omitted from the description. In FIG. 9, the block number is indicated as (row number, column number) and the Z position is indicated by the suffix letter (a, b, c) following the reference numeral 100.

In FIG. 9, 100a(1,1) to 100a(3,3), 100b(1,1) to 100b(3,3) and 100c(1,1) to 100c(3,3) indicate the blocks of image data at respective Z positions. For the purpose of the description, the blocks are depicted as 9 blocks in a 3×3 arrangement, but the number of blocks and the manner of dividing the blocks is not limited to this. In FIG. 9, 101a, 101b, 101c indicate an object image at the respective Z positions.

(Data Reduction Processing for Z Stack Image Data)

The data reduction processing according to the first embodiment is described now with reference to FIG. 1 and FIG. 2. The image data of a plurality of layers (Z positions) is output substantially simultaneously from the plurality of image sensors 1. As FIG. 1 reveals, the image data output by the image sensors 1 at the respective Z positions is input to the signal processing unit 2 and the storage control unit 3. The signal processing unit 2 and the storage control unit 3 process the image data in accordance with the flow shown in FIG. 2. Firstly, the signal processing unit 2 divides the image data of all of the Z positions into blocks (ST100). Thereupon, the signal processing unit 2 selects two or more Z positions from the image data of all of the Z positions (ST101). In step ST101, a portion of the Z positions should be selected. The Z positions (layers) selected here are called selected Z positions (selected layers) or representative Z positions (representative layers). Next, the signal processing unit 2 judges the presence or absence of an object, in each block, by using the image data of the selected Z positions (ST102). The signal processing unit 2 judges, for each block, whether or not the object is included in any of the image data of the selected Z positions (ST103). In the case of a block in which the object is not present in any of the selected Z positions, the signal processing unit 2 instructs the storage control unit 3 to discard the image data of all of the Z positions of that block (ST104). On the other hand, in the case of a block in which an object is present in at least one of the selected Z positions, the image data of all of the Z positions of that block is stored in the storage apparatus 4 (ST105). The processing in ST102 to ST105 is executed for each block. By the operations described above, image data of blocks which do not include the object are discarded, and only image data of blocks which include the object are stored. Therefore, it is possible to reduce the data volume of the Z stack image data and hence the storage capacity of the storage apparatus 4 can be used efficiently.

This can be described more clearly with reference to FIG. 9. The layer image data 100a, 100b, 100c of the Z positions are each divided respectively into 9 blocks by the processing in step ST100. In the following step, ST101, two or more Z positions of the three Z positions are selected. For example, the uppermost layer image data 100a and the bottommost layer image data 100c are selected.

In step ST101, all of the Z positions may be selected. In this case, since the presence or absence of the object is evaluated in respect of all of the image data, then there is no risk of erroneously discarding image data which includes an object image. This method is suitable in the case where there is a small number of layers which constitute the Z stack image data as shown in FIG. 9. However, if there is a large number of layers, it is desirable to select a portion of the layers (Z positions) in order to shorten the processing time for evaluating the presence or absence of the object image. In this case, the selected Z positions and the interval therebetween (number), and the like, should be decided in order to satisfy the conditions indicated below.

As a first condition, at least the Z positions at either end (the uppermost layer and the bottommost layer) of all of the Z positions (focusing positions) should be selected. Although it depends on the method of manufacture of the object and the type of the object, the object on the preparation is often disposed eccentrically towards the upper side or the lower side in the Z direction (thickness direction). Therefore, by evaluating and judging the presence or absence of the object at two or more Z positions including either end, it can be expected that the occurrence of erroneous judgment of the object (overlooking the presence of the object image in a block) will be suppressed.

As a second condition, if the size of the object is known, then the interval between the selected Z positions is set so as to be narrower than the size of the object. The size of the object means, for example, the diameter of a cell or cell nucleus, etc. The information about the size of the object can be provided by the user or can be acquired by measurement and calculation of the object before image capture, or the like. When Z positions are selected to as to achieve an interval narrower than the size of the object, it is possible to detect the object by the image data of any one of the Z positions, and therefore a judgment that the object is absent is never returned in cases where the object actually is included in the block.

Further conditions can be decided from the properties of the optical system 201, and more specifically, the depth of field information. In other words, even if the object is not located in the plane of the focusing position, a well-focused object will be obtained provided that the object is within the range of the depth of field. For example, it is possible to obtain a well-focused image in at least one of the Z positions, by specifying the interval between the selected Z positions so as to be equal to or narrower than the depth of field. By this means, it is possible to prevent erroneous discarding of the image data of a block which includes the object image.

The method of setting the interval on the basis of the size of the object described above is beneficial in cases where the depth of field is narrow compared to the size of the object (where the number of selected Z positions can be made small). On the other hand, the method of setting the interval on the basis of the depth of field is beneficial if the object is smaller than the depth of field. Furthermore, it is also possible to combine these two methods. For example, the interval between the selected Z positions can be set on the basis of the sum value of the object size and the depth of field. Provided that the interval is equal to or smaller than the sum value of the size of the object and the depth of field, it is always possible to obtain a well-focused image in at least one of the Z positions. According to this method, it is possible to further increase the interval between the selected Z positions. More specifically, it is possible to judge the presence or absence of the object in a block, without fail, by using a smaller number of selected Z positions.

In general, the depth of field is defined by the depth contained within the permissible circle of confusion, for example, the permissible circle of confusion is specified as the size of the sensor pixels. In the present embodiment, the presence or absence of an object can be judged accurately by the processing described below, and therefore it is possible to judge the presence or absence of the object even at a depth that is generally larger than the depth of field specified by the permissible circle of confusion. In other words, provided that the object is to judge the presence or absence of an object, it does not matter if the object is slightly blurred. Since the permissible depth varies depending on the processing method used to judge the presence or absence of the object, it is also possible to actually measure whether or not erroneous detection occurs at a depth greater than the depth of field, with each of the processing methods, so as to experimentally determine the permissible depth which produces a desired detection rate, and to then use this permissible depth instead of the depth of field explained in the description given above. Moreover, it is also suitable to determine this permissible depth experimentally as a function of the depth of field. When using the permissible depth, it is possible to judge the presence or absence of the object in the block, by using a smaller number of selected Z positions.

To summarize the foregoing, in order to evaluate the presence or absence of an object, two or more Z positions including the Z positions at either end should be selected. Desirably, the interval between the selected Z positions should be specified on the basis of the size of the object, or the depth of field of the optical system or both of these.

Next, in step ST102, the presence or absence of the object in each block is judged in respect of the image data of the Z positions 100a and 100c. In FIG. 9, a block where the object is judged to be absent is shown in gray. In the subsequent steps (step ST103, step ST104, step ST105), the data of the blocks 100a(1,1), 100b(1,1) and 100c(1,1), 100a(3,2), 100b(3,2) and 100c(3,2), and 100a(3,3), 100b(3,3) and 100c(3,3) in FIG. 9 is deleted and the remaining data is stored in the storage apparatus 4. In this example, since only the data of 6 blocks, out of the 9 blocks, is stored, then it is possible to reduce the data volume to approximately two-thirds, by simple calculation.

(First Method for Judging Presence or Absence of Object)

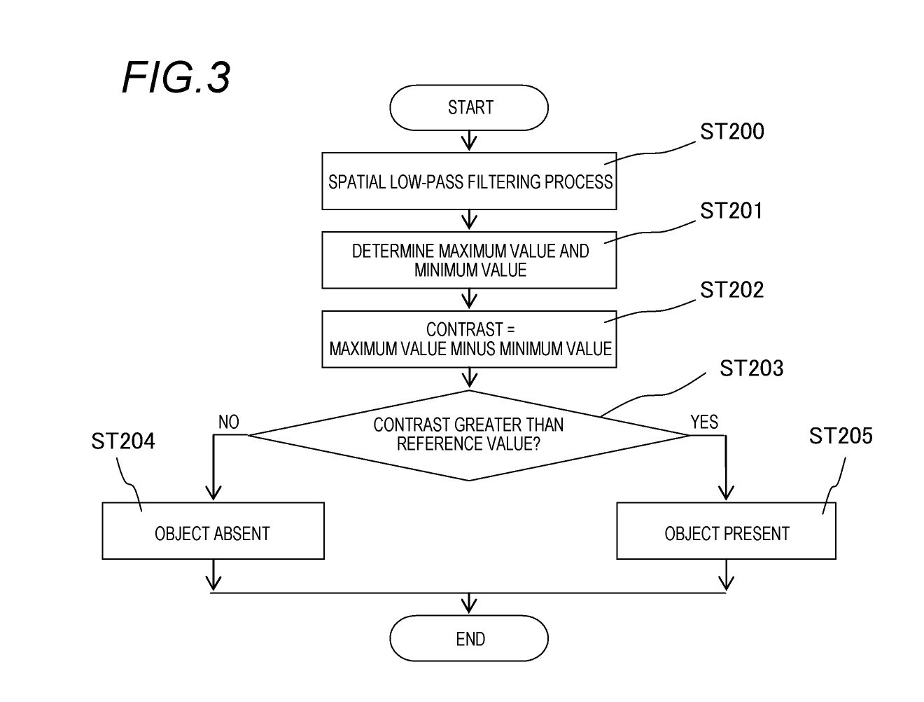

FIG. 3 is a flowchart showing one example of a method of judging the presence or absence of an object in step ST102 in FIG. 2. Below, the first method for judging the presence or absence of an object will be described with reference to FIG. 3. The processing in FIG. 3 is executed respectively for each block, and the presence or absence of the object is judged for each block. Below, the image data of one block is called “block image data”.

Firstly, the signal processing unit 2 applies a spatial low-pass filtering process to the block image data of the selected Z positions (ST200). This low-pass filtering process serves to eliminate image noise caused by noise in the image sensors or dirt on the preparation, and the like, and thereby prevent erroneous judgment in the subsequent processing steps. If the SN ratio of the image data acquired from the imaging element is sufficiently high, then the step ST200 may be omitted. Next, the signal processing unit 2 detects the maximum value and the minimum value of the pixel values in the block image data (ST201). The maximum value and the minimum value can either be detected individually in the RGB data, or can be detected on the basis of brightness data calculated from the RGB data. Alternatively, if the hue of the object is known previously, it is possible to detect the R or G or B data, whichever is nearest to the hue of the object. The signal processing unit 2 then calculates the contrast from the difference between the maximum value and the minimum value (ST202). The signal processing unit 2 judges that the object is absent if the contrast is less than a reference value (first reference level) and judges that the object is present if the contrast is equal to or greater than the reference value (first reference level) (ST203, ST204, ST205). This judgment method is based on the discovery that an image of substantially uniform brightness (in other words, an image with virtually no variation in brightness) is obtained in portions where the object is not present (for example, glass portions of the preparation).

(Second Method for Judging Presence or Absence of Object)

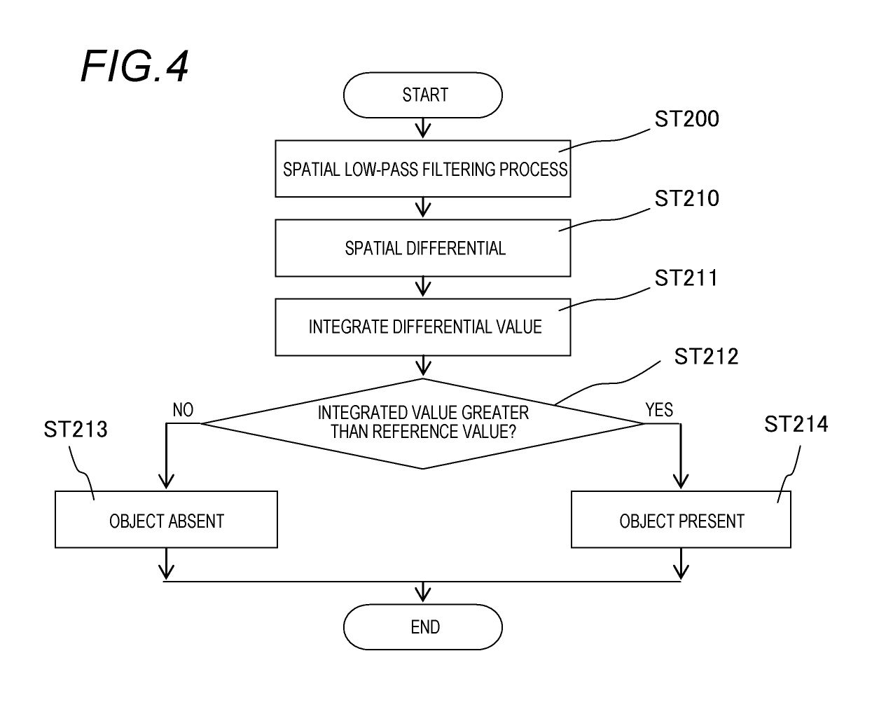

FIG. 4 is a flowchart showing a further example of a method of judging the presence or absence of an object in step ST102 in FIG. 2. Below, the second method for judging the presence or absence of an object will be described with reference to FIG. 4. The processing in FIG. 4 is executed respectively for each block, and the presence or absence of the object is judged for each block.

Firstly, similarly to the first judgment method, the signal processing unit 2 applies a spatial low-pass filtering process to the block image data of the selected Z positions (ST200). Thereupon, the signal processing unit 2 carries out spatial differentiation processing on the block image data (ST210). For example, differential values are calculated respectively for the X direction and the Y direction by applying an X-direction differential filter and a Y-direction differential filter respectively to the block image data. It is also possible to use a second order differential, such as a Laplacian, rather than a first order differential. The differentiation processing may be carried out individually on the RGB data, or may be calculated on the basis of brightness data calculated from the RGB data. Similarly to the case of the first judgment method, it is also possible to calculate the differential value from color data which corresponds to the hue of the object. The edge components of the image data are calculated by this differentiation processing. The signal processing unit 2 then integrates the calculated differential values for the block (ST211). This integration method may find the sum of the absolute values or the sum of the squares. Since the object is to evaluate the extent to which the edge components are included in the block, it is possible to perform a combined calculation without distinguishing between the differential value in the X direction and the differential value in the Y direction. The signal processing unit 2 judges that the object is absent if this integrated value is less than a reference value (second reference level) and judges that the object is present if the integrated value is equal to or greater than the reference value (second reference level) (ST213, ST214). This judgment method is based on the discovery that whereas there is hardly any variation in brightness in the portions where the object is not present, if the object is present, then the outline of the cell nucleus, for example, is detected as an edge component and therefore a significant difference occurs in the integrated amount of the edge component.

(Third Method for Judging Presence or Absence of Object)

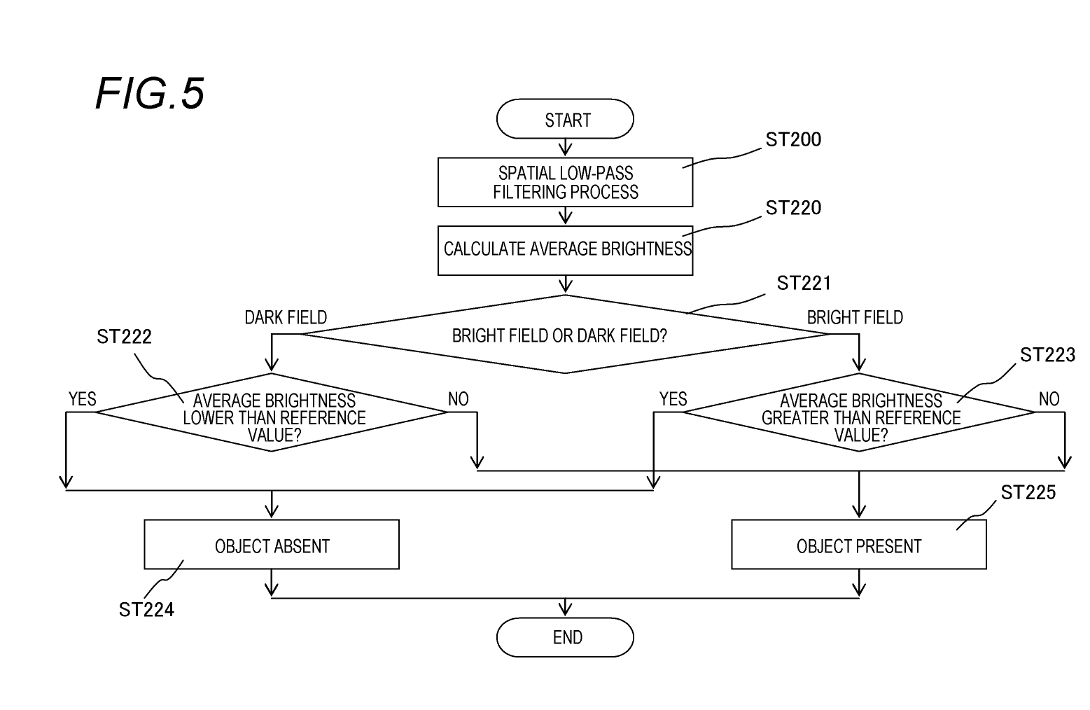

FIG. 5 is a flowchart showing a further example of a method of judging the presence or absence of an object in step ST102 in FIG. 2. Below, the third method for judging the presence or absence of an object will be described with reference to FIG. 5. The processing in FIG. 5 is executed respectively for each block, and the presence or absence of the object is judged for each block.

Firstly, similarly to the first judgment method, the signal processing unit 2 applies a spatial low-pass filtering process to the block image data of the selected Z positions (ST200). Thereupon, the signal processing unit 2 determines the average value of the brightness of the block image data (ST220), and judges the conditions under which the microscope apparatus has performed image capture. More specifically, the signal processing unit 2 judges whether the field of view is a bright field (projection of transmitted light) in which the background is bright, or a dark field (epi-illumination or polarizing microscope apparatus) in which the background is dark (ST221). In the case of image data which is captured in a dark field, the signal processing unit 2 judges that the object is absent if the average value of the brightness is less than a reference value (third reference level) and judges that the object is present if the average value is equal to or greater than the reference value (third reference level) (ST222, ST224, ST225). In the case of image data which is captured in a bright field, the signal processing unit 2 judges that the object is absent if the average value of the brightness is greater than a reference value (fourth reference level) and judges that the object is present if the average value is equal to or lower than the reference value (fourth reference level) (ST223, ST224, ST225). This judgment method is based on the discovery that a significant difference in brightness with respect to the background occurs in the portion of the object (namely, the portion of the object is brighter in the case of a dark field and the portion of the object is darker in the case of a bright field).

As described above, in the first embodiment of the present invention, control is implemented in such a manner that the presence or absence of the object is evaluated for each block and the image data of all Z positions is discarded and is not stored in the storage apparatus 4, in respect of any block which is judged not to include the object. Therefore, it is possible to reduce the data volume of the Z stack image data. As a result of this, it is possible to reduce the storage capacity of the storage apparatus 4, in other words, to lower the cost of the storage apparatus 4. Since the data of blocks where the object is not present is deleted, then the amount of information which is required for observation and diagnosis is not lost.

The data reduction method according to the present embodiment has a benefit in that, in a method for evaluating the presence or absence of the object in block units, it is possible to start sequential processing, as block image data of all layers (Z positions) is obtained, even if image capture of the whole image has not yet been completed. Consequently, the data reduction method according to the present embodiment is particularly suitable for application to a digital microscope apparatus of a composition in which image data of a plurality of Z positions can be captured in substantially simultaneous fashion using a plurality of image sensors having different focusing positions.

### Second Embodiment

In the second embodiment of the present invention, a block which is judged to be stored (not discarded) by the method of the first embodiment is further divided into finer sub-blocks, and similar evaluation is carried out in respect of the sub-blocks. By not storing (discarding) the image data of all Z positions in a sub-block where the object is judged to be absent, the data is reduced even further than the method according to the first embodiment.

The actual composition of the digital microscope apparatus is substantially the same as that according to the first embodiment (FIG. 1), and therefore description thereof is omitted here. The points of difference of the second embodiment with respect to the first embodiment involve the processing of the signal processing unit 2 and the storage control unit 3 for the purpose of reducing the image data.

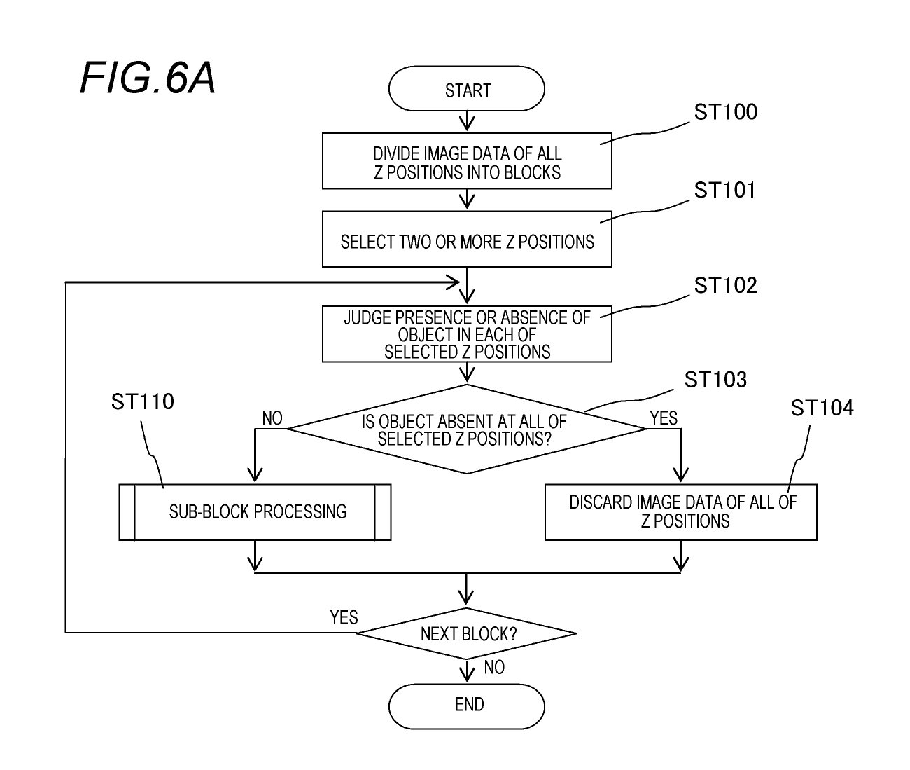

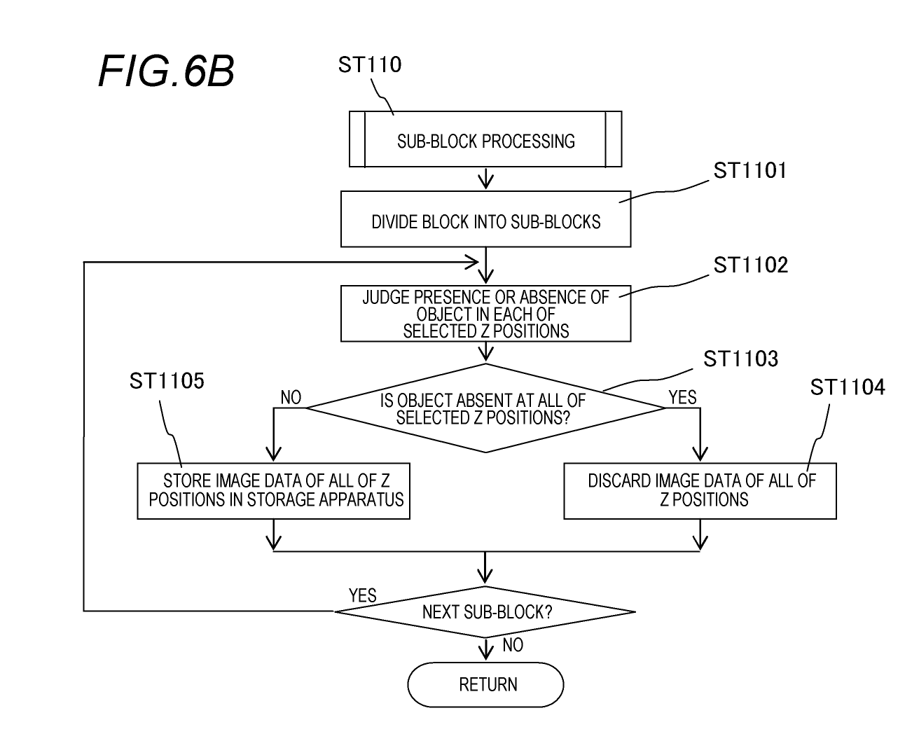

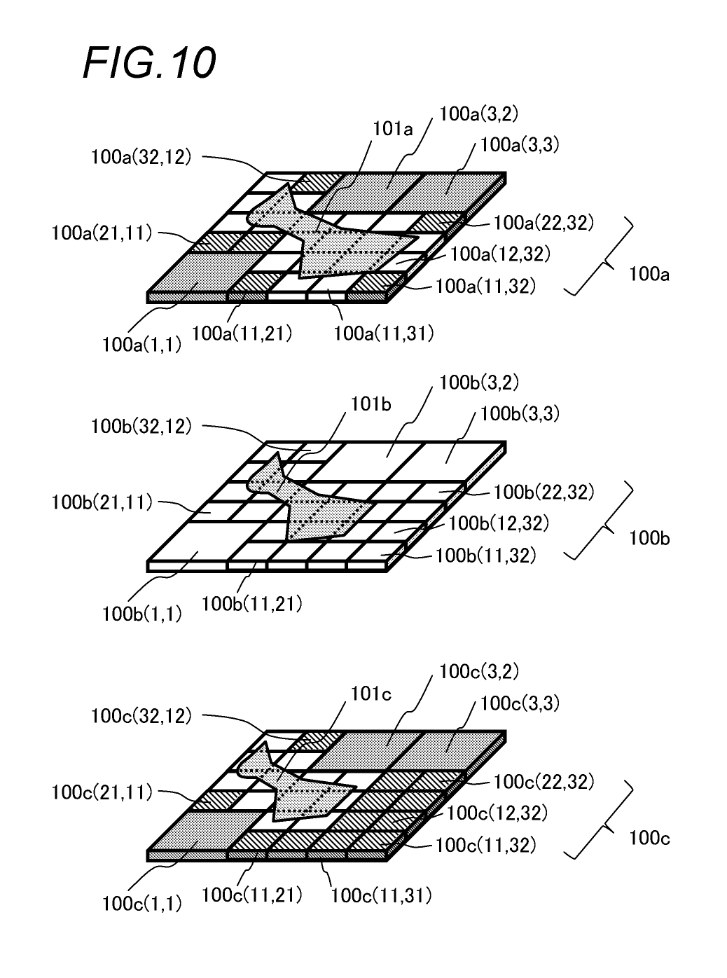

FIG. 6A and FIG. 6B are diagrams showing a flow of image data reduction processing according to a second embodiment of the present invention. FIG. 10 is a diagram showing a schematic view of Z stack image data according to the second embodiment of the present invention. In FIG. 10, reference numerals which are the same as those described with reference to FIG. 9 are omitted from the description. In FIG. 10, the blocks colored gray 100a(1,1), 100b(1,1), 100c(1,1), 100a(3,2), 100b(3,2), 100c(3,2), 100a(3,3), 100b(3,3) and 100c(3,3) are blocks that are judged to be not for storing (that are to be deleted) in the first embodiment.

FIG. 10 shows an example in which blocks which are judged to be for storing (not to be discarded) are divided further into sub-blocks (for example, 100a(11,21), 100b(11,21), 100c(11,21)). In this example, the whole image is divided into 3×3=9 blocks, and the blocks are divided into 2×2=4 sub-blocks, but the method of dividing the blocks and the number of divisions are not limited to these.

The second embodiment of the present invention is now described with reference to FIG. 6A and FIG. 6B. Firstly, the signal processing unit 2 divides the image data for all of the Z positions into blocks (ST100). Thereupon, the signal processing unit 2 selects two or more Z positions from the image data of all of the Z positions (ST101). Next, the signal processing unit 2 judges the presence or absence of an object, in each block, by using the image data of the selected Z positions (ST102). The signal processing unit 2 judges, for each block, whether or not the object is included in any of the selected Z positions (ST103). In the case of a block in which the object is not present in any of the selected Z positions, the signal processing unit 2 instructs the storage control unit 3 to discard the image data of all of the Z positions of that block (ST104). The processing to this point is similar to the processing according to the first embodiment.

In ST103, if it is judged that the object is present in at least one of the selected Z positions, the signal processing unit 2 applies sub-block processing to the block in question (ST110). FIG. 6B shows details of the sub-block processing ST110. Firstly, the signal processing unit 2 further divides the block in question into sub-blocks (ST1101). The signal processing unit 2 judges the presence or absence of an object, in each sub-block, by using the image data of the selected Z positions (ST1102). The judgment algorithm used here may be the same as that of step ST102 in FIG. 6A. The signal processing unit 2 judges, for each sub-block, whether or not the object is included at any of the selected Z positions (ST1103). In the case of a sub-block in which the object is not present in any of the selected Z positions, the signal processing unit 2 instructs the storage control unit 3 to discard the image data of all of the Z positions of that sub-block (ST1104). On the other hand, in the case of a sub-block in which the object is present in at least one of the selected Z positions, the image data of all of the Z positions of that sub-block is stored in the storage apparatus 4 (ST1105). The processing from ST1102 to ST1105 is executed for each sub-block and the procedure returns to the flow in FIG. 6A when the processing has been completed for all of the sub-blocks.

By the operation described above, since the image data of blocks and sub-blocks that do not include the object image is discarded, then it is possible to reduce the data volume of the Z stack image data even further than in the method according to the first embodiment.

This can be described more clearly with reference to FIG. 10. The layer image data 100a, 100b, 100c of the Z positions are each divided respectively into 9 blocks by the processing in step ST100. In the following step, ST101, two or more Z positions of the three Z positions are selected. For example, the uppermost layer image data 100a and the bottommost layer image data 100c are selected. The method for specifying the selected Z positions uses the same method as that described in the first embodiment.

Next, in step ST102, the presence or absence of the object in each block is judged in respect of the image data of the Z positions 100a and 100c. In FIG. 10, a block where the object is judged to be absent is shown in gray. In the subsequent steps (step ST103, step ST104), the image data of the blocks 100a(1,1), 100b(1,1) and 100c(1,1), 100a(3,2), 100b(3,2) and 100c(3,2), and 100a(3,3), 100b(3,3) and 100c(3,3) is deleted.

On the other hand, a block where the object is judged to be present in step ST103 is divided further into sub-blocks (ST1101). In step ST1102, the presence or absence of the object in each sub-block is judged in respect of the image data of the Z positions 100a and 100c. In FIG. 10, a sub-block where the object is judged to be absent is shown by hatching (diagonal lines). In steps ST1103 to ST1105, the image data of the sub-blocks 100a(11,21), 100b(11,21) and 100c(11,21), 100a(11,32), 100b(11,32) and 100c(11,32), 100a(21,11), 100b(21,11) and 100c(21,11), 100a(22,32), 100b(22,32) and 100c(22,32), and 100a(32,12), 100b(32,12) and 100c(32,12) in FIG. 10, is deleted and the remaining data is stored in the storage apparatus 4. For example, the object is judged to be present in the sub-block 100a(11,31) which corresponds to the Z position of 100a, and therefore, the sub-block 100c(11,31) is not discarded.

As described above, in the second embodiment of the present invention, control is implemented in such a manner that the presence or absence of the object is evaluated for each block and the image data of all Z positions is discarded and is not stored in the storage apparatus 4, in respect of any block which is judged not to include the object. Moreover, the presence or absence of the object is evaluated in units of finer sub-blocks in the case of blocks which are judged to include the object, and the image data of all of the Z positions is discarded in respect of sub-blocks which are judged not to include the object. By this means, it is possible to reduce the data volume of the Z stack image data even further than with the method according to the first embodiment. As a result of this, it is possible to reduce the storage capacity of the storage apparatus 4, in other words, to lower the cost of the storage apparatus 4. Since the data of blocks where the object is not present is deleted, then the amount of information which is required for observation and diagnosis is not lost. Consequently, the data reduction method according to the second embodiment is also particularly suitable for application to a digital microscope apparatus of a composition in which image data of a plurality of Z positions can be captured in substantially simultaneous fashion using a plurality of image sensors having different focusing positions.

In the second embodiment which was described above, the whole image is divided into 3×3=9 blocks, and the blocks are each divided into 2×2=4 sub-blocks, but the method of dividing the blocks and the number of divisions is not limited to this. For example, the smaller the size of the blocks and sub-blocks (the greater the number of divisions), the greater the data reducing effect that can be expected. Furthermore, it is also possible to employ yet finer divisions, rather than just the two levels of block divisions and sub-block divisions. More specifically, it is possible to divide a sub-block which has been judged to include the object into yet smaller regions, and to evaluate the presence or absence of the object and judge whether to discard or store the data, respectively for each small region. By this means, an even greater data reducing effect can be expected.

### Third Embodiment

In the first and second embodiments, all of the data of a block where the object is present was stored. However, in the third embodiment, even if the object is present in a block, rather than storing the image data for all Z positions, control is implemented so as to discard the image data of Z positions which do not include the object image (or which have a high possibility of not including the object image).

The actual composition of the digital microscope apparatus is substantially the same as that according to the first embodiment (FIG. 1), and therefore description thereof is omitted here. The points of difference of the third embodiment with respect to the first embodiment involve the processing of the signal processing unit 2 and the storage control unit 3 for the purpose of reducing the image data.

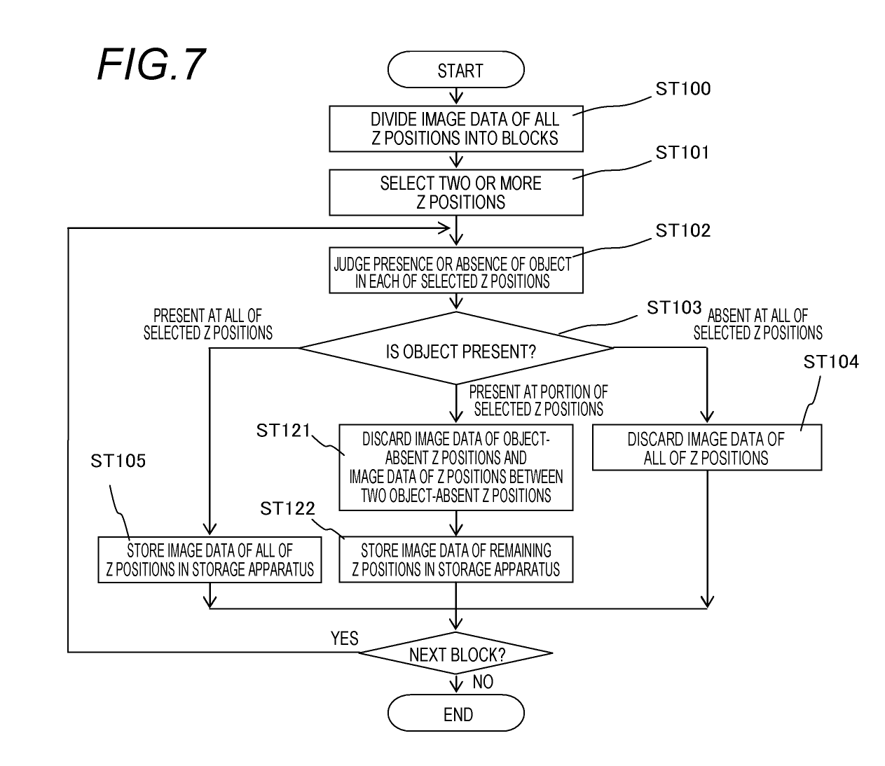

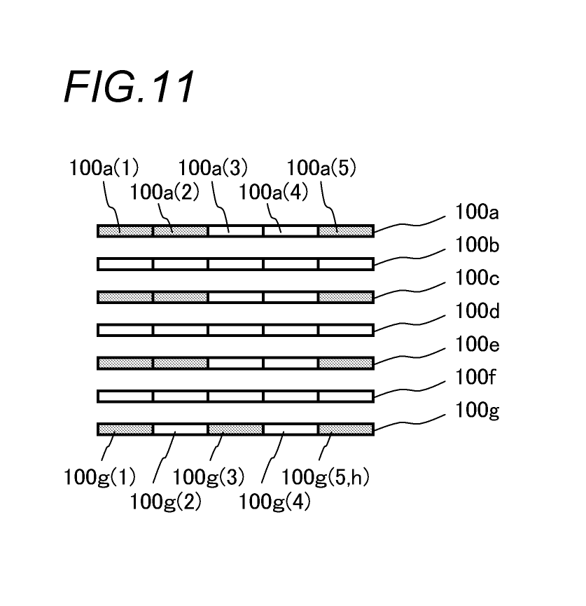

FIG. 7 is a diagram showing a flow of image data reduction processing according to a third embodiment of the present invention. FIG. 11 is a diagram showing a schematic view of Z stack image data according to the third embodiment of the present invention.

The horizontal axis in FIG. 11 indicates one axis in the planar direction (for example, the X direction), and the vertical axis indicates a Z position. FIG. 11 shows an example where Z stack image data including 7 layers from 100a to 100g (7 Z positions) is divided into five blocks. In FIG. 11, the suffix letters a to g appended to the reference numerals represent the Z position and the numbers in parenthesis (1) to (5) represent the block numbers. FIG. 11 shows only the reference numerals of a portion of the block image data, but each block of the image data 100b of the second Z position from the top, for example, can be represented as 100b(1), 100b(2), . . . , 100b(5), in sequence from the left-hand side in FIG. 11. This also applies similarly to other drawings. The number of layers and the number of blocks in FIG. 11 are examples and it is also possible to apply the method of the present embodiment in the case of a number of layers or a number of blocks which are different to these.

The third embodiment of the present invention is now described with reference to FIG. 7. Firstly, the signal processing unit 2 divides the image data for all of the Z positions into blocks (ST100). Thereupon, the signal processing unit 2 selects two or more Z positions from the image data of all of the Z positions (ST101). Next, the signal processing unit 2 judges the presence or absence of an object, in each block, by using the image data of the selected Z positions (ST102). The signal processing unit 2 judges, for each block, whether or not the object is included at any of the selected Z positions (ST103). In the case of a block in which the object is not present in any of the selected Z positions, the signal processing unit 2 instructs the storage control unit 3 to discard the image data of all of the Z positions of that block (ST104). The processing to this point is similar to the processing according to the first embodiment.

In ST103, if it is judged that the object is present in all of the selected Z positions, then the image data of all of the Z positions of the block is stored in the storage apparatus 4 (ST105). In ST103, if it is judged that the object is present only in a portion of the selected Z positions (in other words, that the object is not present in a portion of the selected Z positions), then the procedure advances to the processing in ST121. In ST121, the signal processing unit 2 discards the image data of the selected Z positions where the object is judged not to be present (called the “object-absent Z positions” or the “object-absent layers” below). Moreover, if two or more object-absent Z positions appear consecutively in the Z direction, then the signal processing unit 2 also discards the image data of the Z positions (Z positions that are not selected Z positions) situated between the two consecutive object-absent Z positions. Only the image data of the Z positions other than those instructed for discarding in ST121 are stored in the storage apparatus 4 (ST122). In other words, the data stored in the storage apparatus 4 is image data of the selected Z positions where the object is judged to be present and Z positions in the vicinity thereof (to the upper side and the lower side). By means of the operation described above, only image data which includes an object image and image data having a high probability of including the object image is stored, and unnecessary data is discarded. The processing in ST102 to ST122 is executed for each block.

This can be described more clearly with reference to FIG. 11. The layer image data 100a to 100g of the respective Z positions are each divided respectively into 5 blocks by the processing in step ST100. In the following step, ST101, two or more Z positions of the seven Z positions are selected. For example, the four Z positions 100a, 100c, 100e, 100g are selected. These selected Z positions are examples, and the number of positions selected and the interval therebetween should be specified appropriately in accordance with the size of the object and the depth of field, as stated previously.

Next, in step ST102, the presence or absence of the object in each block is judged in respect of the image data of the selected Z positions 100a, 100c, 100e and 100g. In FIG. 11, a block where the object is judged to be absent is shown in gray. In the next steps (ST103, ST104), the image data of the first blocks from 100a(1) to 100g(1) and the image data of the fifth blocks from 100a(5) to 100g(5), in which the object is judged to be absent in all of the selected Z positions, are discarded. In the first embodiment, the processing is conducted up to this point.

The image data of the fourth blocks from 100a(4) to 100g(4) in which the object has been detected at all of the selected Z positions is stored in the storage apparatus 4 (step ST105). The processing of steps ST121 and ST122 is applied to the second and third blocks in which the object is detected only in a portion of the selected Z positions. In other words, of the image data of the second block, the image data of 100a(2), 100c(2), 100e(2) corresponding to the object-absent Z positions, and the image data of the Z positions 100b(2), 100d(2) located between these, are discarded. The remaining image data for 100f(2) and 100g(2) is stored in the storage apparatus 4. In the third block, the image data of 100g(3) which corresponds to the object-absent Z position is discarded, and the remaining image data of 100a(3) to 100f(3) is stored in the storage apparatus 4.

In the first and second embodiments, the data of blocks or sub-blocks where the object is present are all stored, whereas in the third embodiment, a judgment is made for each Z position and only image data which includes an object image and image data that has a high probability of including the object image is stored. Consequently, it is possible to reduce the data volume of the Z stack image data even further than with the methods according to the first and second embodiments. As a result of this, it is possible to reduce the storage capacity of the storage apparatus 4, in other words, to lower the cost of the storage apparatus. Since only the data of blocks and Z positions where the object is not present is deleted, then the amount of information which is required for observation and diagnosis is not lost. Consequently, the data reduction method according to the third embodiment is also particularly suitable for application to a digital microscope apparatus of a composition in which image data of a plurality of Z positions can be captured in substantially simultaneous fashion using a plurality of image sensors having different focusing positions. Of course, desirably, the method described in the third embodiment is applied to the method described in the second embodiment (sub-block division).

### Fourth Embodiment

In the embodiments described above, an example is described in which image data that is not required by the observer is deleted. In a further embodiment of the present invention, it is also possible to reduce the image data size by performing encoding for increasing the compression ratio, rather than deleting the image data. More specifically, encoding without compression or with a low compression ratio is applied to the image data of blocks or Z positions which are judged to include the object in the methods of the first to third embodiments, and encoding with a high compression ratio is applied to image data of blocks or Z positions which are judged not to include the object. The compression algorithm can be varied between the former case (low compression ratio) and the latter case (high compression ratio). For the compression algorithm, it is possible to employ any algorithm, such as JPEG, JPEG2000, or the like. These processes are performed by the storage control unit 3 in accordance with a judgment made by the signal processing unit 2. For example, this can be achieved by substituting the “discarding step” of the flowchart described above with a “step of encoding with a high compression ratio and storing in a storage apparatus”.

The advantages of the fourth embodiment are as indicated below. In the embodiments described above, the presence or absence of the object is judged by the methods shown in FIG. 3 to FIG. 5, but in this case, there is no guarantee that erroneous judgment will not occur. However, in the first to third embodiments, since the image data itself is discarded, then even if an erroneous judgment is discovered at a later stage, there is no way to check the image data of the discarded portion. On the other hand, with the method of the fourth embodiment, even though the compression ratio is high (the image quality is poor), image data remains and therefore it is possible to check the contents of the image, at the least.

An erroneous judgment according to which, when judging the presence or absence of the object, it is judged that the object is absent even though the object is actually present, occurs frequently when the object occupies an extremely small ratio of the block surface area. In cases of this kind, even if encoding with a high compression rate is carried out, since a large data volume is assigned to the image data of the portions where the object is present, then there is relatively little deterioration of the image quality in the portion where the object is present. Consequently, according to the method of the fourth embodiment, sufficient beneficial effects can be expected even if the data volume is increased slightly with respect to the methods according to the first to third embodiments.

### Fifth Embodiment

In the fifth embodiment, similarly to the fourth embodiment, instead of deleting the image data which is not required by the observer, image data is reduced by combining (merging) the image data of a plurality of Z positions into one image data.

More specifically, one image data is synthesized from the image data of a plurality of Z positions in the blocks or sub-blocks which are judged not to include the object by the method according to the first to third embodiments. For example, one image data is synthesized from the image data of a plurality of Z positions by the method disclosed in Japanese Patent Application Publication No. 2005-037902 or by the method disclosed in Japanese Patent Application Publication No. 2007-128009. This synthesized image may also be called a focus-stacked image, which is formed by combining the images of a plurality of Z positions to create one image which is well focused in substantially the whole region of the image. In the fifth embodiment of the present invention, in a block or sub-block which is judged not to include the object, it is possible to reduce the image data volume by creating one image data through focus stacking of this kind. These processes are performed by the storage control unit 3 in accordance with a judgment made by the signal processing unit 2. For example, this can be achieved by substituting the “discarding step” of the flowchart described above with a “step of performing focus stacking and storing focus-stacked image data in the storage apparatus”. If there is an isolated Z position of a block or sub-block which is deleted in the third embodiment (in other words, if there is not a plurality of consecutive Z positions which are deleted), then the reduction of the image data according to the fifth embodiment is not carried out. However, in general, there are not many cases where the Z position of the block or the sub-block which is reduced in this way is an isolated position, and therefore a beneficial effect in reducing the image data is also obtained sufficiently even in the case of the fifth embodiment.

The advantages of the fifth embodiment are as indicated below. As described above, the presence or absence of the object is judged by the methods shown in FIG. 3 to FIG. 5 in the present invention, but in this case, there is no guarantee that erroneous judgment will not occur. However, in the first to third embodiments, since the image data itself is discarded, then even if an erroneous judgment is discovered at a later stage, there is no way to check the image data of the discarded portion. On the other hand, with the method according to the fifth embodiment, the image data of a plurality of Z positions is synthesized into one image data in blocks or sub-blocks where the object is judged to be absent. Therefore, it is possible to leave image data which at least enables confirmation of the contents of the image, similarly to the fourth embodiment. In the fourth embodiment, the image data for all Z positions is compressed and saved (although the image quality becomes poor), whereas in the fifth embodiment, focus stacking is carried out to synthesize the image data into one image data. Therefore, it is possible to store an image which is well focused on the object, if an object is present, in blocks or sub-blocks where the object has been judged to be absent. Consequently, there is an advantage in that blocks or sub-blocks where it has been judged erroneously that the object is absent can be checked readily by observing the stored image data.

Moreover, similarly to the description relating to the fourth embodiment, the image obtained by focus stacking in the fifth embodiment may be encoded using a high compression ratio so as to further reduce the image data size. More specifically, encoding without compression or with a low compression ratio is used for the image data of blocks or Z positions which have been judged to include the object according to the methods of the first to third embodiments. Depth-synthesized image data is created by focus stacking of the image data of a plurality of Z positions of blocks or sub-blocks which are judged not to include the object, and encoding with an even higher compression ratio is used for this image data. By using processing of this kind, it is possible to reduce the image data size yet further.

### Other Embodiments

The following procedure should be adopted when displaying the Z stack image data created by the methods according to the first and second embodiments with a viewer. In blocks where there is no image data (where the image data has been discarded), an image indicating that no image data exists (for example, a message stating “no data” or the like) should be superimposed on the display region for that block. Furthermore, if there is an extreme difference in brightness between the blocks where there is no image data and the peripheral blocks, then greater fatigue is caused to the eyes of the observer. Therefore, for example, the brightness and color of the blocks where there is no image data should be calculated from the image data of the peripheral blocks (for example, the average brightness of the image data of the peripheral blocks, or the like). Alternatively, in the case of a dark field microscopic image, black data (data of low brightness) may be displayed in blocks where there is no image data, and in the case of a bright field microscopic image, white data (data of high brightness) may be displayed in blocks where there is no image data. In this way, by adjusting (switching) the display brightness of the blocks where there is no image data in accordance with the image data of the peripheral blocks, and the like, it is possible to reduce the fatigue and sense of discomfort caused to the observer.

Furthermore, when displaying image data at Z positions which has been deleted as in the third embodiment, it is possible to create and display the deleted image data on the basis of the image data of other Z positions, at the least. For example, it is also possible to create image data for deleted Z positions by convoluting the spread function (transmission function) of the optical system 201 to the original image data.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., non-transitory computer-readable medium). Therefore, the computer (including the device such as a CPU or MPU), the method, the program (including a program code and a program product), and the non-transitory computer-readable medium recording the program are all included within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-151170, filed on Jul. 5, 2012, and Japanese Patent Application No. 2013-009163, filed on Jan. 22, 2013, which are hereby incorporated by reference herein in their entirety.

What is claimed is:

1. A microscope apparatus which captures images of an object by a plurality of image sensors having different focusing positions in an optical axis direction and acquires image data of a plurality of layers of the object, comprising:
a judgment unit which divides a whole region of the image data obtained from the image sensors into a plurality of blocks and judges whether or not each block includes an object image; and
a data reducing unit which reduces a data volume of the image data of all of the layers in a block which is judged by the judgment unit not to include an object image,
wherein the judgment unit selects two or more layers from a plurality of layers of a block which is being subjected to judgment, respectively evaluates whether or not the image data of the two or more selected layers includes the object image, and judges whether or not the block includes the object image on the basis of the evaluation results.

2. The microscope apparatus according to claim 1, wherein the judgment unit judges that the block does not include the object image if none of the image data of the two or more selected layers includes an object image.

3. The microscope apparatus according to claim 1, wherein the judgment unit selects at least an uppermost layer and a bottommost layer of the plurality of layers as the two or more selected layers.

4. The microscope apparatus according to claim 1, wherein the judgment unit specifies an interval between the two or more selected layers on the basis of either one or both of a size of the object and a depth of field of the microscope apparatus, in such a manner that, if the object is present, the image data of at least one of the selected layers includes an object image.

5. The microscope apparatus according to claim 1,
wherein the judgment unit further divides a block which is judged to include the object image, into a plurality of sub-blocks, and judges whether or not each sub-block includes an object image, and
the data reducing unit reduces a data volume of the image data of all layers of a sub-block which is judged by the judgment unit not to include the object image.

6. The microscope apparatus according to claim 1, wherein, in cases where the object image is included in the image data of only a portion of layers, of the plurality of layers of a block which is judged to include the object image, the judgment unit judges the layers which do not include the object image, from the plurality of layers of the block, and the data reducing unit reduces a data volume of the image data of the layers which are judged by the judgment unit not to include the object image.

7. The microscope apparatus according to claim 5, wherein, in cases where the object image is included in the image data of only a portion of the layers, of the plurality of layers of a sub-block which is judged to include the object image, the judgment unit judges the layers which do not include the object image, from the plurality of layers of the sub-block, and the data reducing unit reduces a data volume of the image data of the layers which are judged by the judgment unit not to include the object image.

8. The microscope apparatus according to claim 6, wherein the judgment unit judges object-absent layers, of the two or more selected layers, which are evaluated as not including the object image, and layers, of the unselected layers, which are located between two consecutive object-absent layers, to be layers which do not include the object image.

9. The microscope apparatus according to claim 1, wherein the data reducing unit reduces the data volume by deleting image data which is judged by the judgment unit not to include the object image, or by encoding this image data with a higher compression ratio than other image data.

10. The microscope apparatus according to claim 1, wherein the data reducing unit reduces the data volume by creating focus-stacked image data from image data of a plurality of layers judged by the judgment unit not to include the object image.

11. The microscope apparatus according to claim 1, wherein the judgment unit calculates a contrast of image data and judges that the image data does not include the object image if the contrast is lower than a first reference level.

12. The microscope apparatus according to claim 1, wherein the judgment unit calculates an integrated amount of an edge component of image data and judges that the image data does not include the object image if the integrated amount of the edge component is lower than a second reference level.

13. The microscope apparatus according to claim 1,
wherein the judgment unit calculates an average value of a brightness of image data, and
judges that the image data does not include the object image if the average value of the brightness is lower than a third reference level in cases where the image data is obtained in a dark field; or
judges that the image data does not include the object image if the average value of the brightness is greater than a fourth reference level in cases where the image data is obtained in a bright field.

14. The microscope apparatus according to claim 1,
wherein the plurality of image sensors are a plurality of line image sensors which are formed on one semiconductor chip, and
the focusing positions of the plurality of line image sensors are made respectively different by installing the semiconductor chip obliquely with respect to a plane perpendicular to an optical axis of an optical system.

15. The microscope apparatus according to claim 1,
wherein the plurality of image sensors are a plurality of area image sensors, and
the focusing positions of the plurality of area image sensors are made respectively different by making optical path lengths from an optical system to the area image sensors respectively different.

16. A control method for a microscope apparatus which captures images of an object by a plurality of image sensors having different focusing positions in an optical axis direction and acquires image data of a plurality of layers of the object; the control method comprising:
a judgment step of dividing a whole region of the image data obtained from the image sensors into a plurality of blocks and judging whether or not each block includes an object image; and
a data reducing step of reducing a data volume of the image data of all of the layers in a block which is judged in the judgment step not to include an object image;
wherein, in the judgment step, two or more layers are selected from a plurality of layers of a block which is being subjected to judgment, it is respectively evaluated whether or not the image data of the two or more selected layers includes the object image, and it is judged whether or not the block includes the object image on the basis of the evaluation results.

17. The control method for a microscope apparatus according to claim 16,
wherein, in the judgment step, a block which is judged to include the object image is further divided into a plurality of sub-blocks, and it is judged whether or not each sub-block includes an object image, and
in the data reducing step, a data volume of the image data of all layers of a sub-block which is judged in the judgment step not to include the object image is reduced.

18. The control method for a microscope apparatus according to claim 16, wherein, in cases where the object image is included in the image data of only a portion of layers, of the plurality of layers of the block which is judged to include the object image, the layers which do not include the object image are judged from the plurality of layers of the block in the judgment step, and a data volume of the image data of the layers which are judged in the judgment step not to include the object image is reduced in the data reducing step.

19. The control method for a microscope apparatus according to claim 17, wherein, in cases where the object image is included in the image data of only a portion of layers, of the plurality of layers of a sub-block which is judged to include the object image, the layers which do not include the object image are judged from the plurality of layers of the sub-block in the judgment step, and a data volume of the image data of the layers which are judged in the judgment step not to include the object image is reduced in the data reducing step.

20. The control method for a microscope apparatus according to claim 18, wherein, in the judgment step, object-absent layers, of the two or more selected layers, which are evaluated as not including the object image, and layers, of the unselected layers, which are located between two consecutive object-absent layers, are judged to be layers which do not include the object image.
